(19) United States
(12) Patent Application Publication
(10) Pub. No.: US 2010/0168332 A1
(43) Pub. Date: Jul. 1, 2010

(54) Polylactic Acid Resin Composition and Molded Product Using the Same

(75) Inventors: Young-Mi CHUNG, Uiwang-si (KR); Doo-Han HA, Uiwang-si (KR); Chang-Do JUNG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/649,471

(22) Filed: Dec. 30, 2009

(30) Foreign Application Priority Data
Dec. 30, 2008 (KR) 10-2008-0137224

(51) Int. Cl. C08L 51/04

(52) U.S. Cl. 525/71; 525/78

(57) ABSTRACT

Disclosed are a polylactic acid resin composition that includes (A) about 10 to about 80 wt % of a polylactic acid resin; (B) about 5 to about 50 wt % of a rubber modified vinyl-based graft copolymer; (C) about 10 to about 80 wt % of a vinyl-based copolymer; and (D) about 5 to about 75 wt % of poly(meth)acrylic acid alkyl ester, and a molded product made using the same.

### CROSS REFERENCE TO RELATED APPLICATIONS

This application claims priority to and the benefit of Korean Patent Application No. 10-2008-0137224 filed in the Korean Intellectual Property Office on Dec. 30, 2008, the entire disclosure of which is incorporated herein by reference.

### FIELD OF THE INVENTION

This disclosure relates to a polylactic acid resin composition and a molded product made using the same.

### BACKGROUND OF THE INVENTION

There has been much research on the development of strong and safe polymer materials for special purposes. However, as discarded polymers have become socially recognized as a severe environmental problem all over the world, there is a need to develop an environmentally-friendly polymer material.

Environmentally friendly polymers may be mainly classified into photodegradable polymers and biodegradable polymers. Biodegradable polymers include a functional group that can be decomposed by microorganisms. Among these polymers, aliphatic polyester polymer has gained the most attention, since it has excellent workability and easily adjustable decomposition characteristics. In particular, polylactic acid (PLA) has a market share of about 150,000 tons in the world and expansively covers applications where common plastic is used, for example in food packaging materials and containers, cases for electronics, and the like. At present, polylactic acid resin is mainly used for disposable products such as food containers, wraps, films, and the like due to its biodegradable characteristics. Examples of polylactic acid resin are manufactured by American NatureWorks LLC., Japanese Toyota and the like.

However, since a conventional polylactic acid resin lacks formability, mechanical strength, and heat resistance, a thin film made therefrom can be easily destroyed. Since it has low resistance against high temperatures, a molded product made therefrom can be distorted at about 60° C. or higher.

Japanese Patent Laid-Open Publication Nos. 2005-220177, 2005-200517 and 2005-336220 disclose simultaneously improving heat resistance and mechanical strength by adding glass fiber to a resin composition. However, the resin composition does not have a stable molding workability and has weak impact strength or poor hydrolysis resistance.

A composition including a polylactic acid resin and an acrylonitrile-butadiene-styrene (ABS) resin can exhibit increased heat resistance. Styrene-based thermoplastic resins such as acrylonitrile-butadiene-styrene resin have excellent impact resistance, mechanical strength, surface characteristics, and workability, and thus it are widely used for electrical/electronic products, automobile interior/exterior parts, and general merchandise. In addition, maleimide-based ABS can have good heat resistance and molding properties, and thus is useful in a variety of applications such as automobile interior/exterior materials requiring heat resistance. Japanese Patent Laid-Open Publication No. 1999-279380 and 2006-070224 disclose a composition including polylactic acid resin and acrylonitrile-butadiene-styrene resin. However, these resin compositions do not have excellent appearance characteristics or gloss.

International Patent Publication No. WO 2005/123831 and Japanese Patent Laid-Open Publication No. 2005-171204 disclose compositions prepared by mixing a polylactic acid resin with a polymethylmethacrylate resin to improve the transparency and molding property of polylactic acid resin. However, the resin compositions do not have excellent impact resistance.

### SUMMARY OF THE INVENTION

One aspect of the invention provides a polylactic acid resin composition that can have excellent hydrolysis resistance, appearance characteristics, gloss, and impact resistance.

Another aspect of the present invention provides a molded product made using the polylactic acid resin composition.

According to one aspect of the invention, a polylactic acid resin composition is provided that includes (A) about 10 to about 80 wt % of a polylactic acid resin; (B) about 5 to about 50 wt % of a rubber modified vinyl-based graft copolymer; (C) about 10 to about 80 wt % of a vinyl-based copolymer; and (D) about 5 to about 75 wt % of poly(meth)acrylic acid alkyl ester.

The rubber modified vinyl-based graft copolymer (B) may include about 5 to about 95 wt % of a vinyl-based polymer including about 50 to about 95 wt % a first vinyl-based monomer comprising an aromatic vinyl monomer, an acrylic-based monomer, or a combination thereof; and about 5 to about 50 wt % of a second vinyl-based monomer comprising an unsaturated nitrile monomer, an acrylic-based monomer which is different from the first acrylic-based monomer of the rubber modified vinyl-based graft copolymer (B), or a combination thereof, which are grafted onto about 5 to about 95 wt % of a rubber polymer comprising a butadiene rubber, an acrylic rubber, an ethylene/propylene rubber, a styrene/butadiene rubber, an acrylonitrile/butadiene rubber, an isoprene rubber, an ethylene-propylene-diene terpolymer, a polyorganosiloxane/polyalkyl(meth)acrylate rubber composite, or a combination thereof.

The vinyl-based copolymer (C) may include a copolymer of about 40 to about 95 wt % of a first vinyl-based monomer comprising an aromatic vinyl monomer, an acrylic-based monomer, a heterocyclic monomer, or a combination thereof; and about 5 to about 60 wt % of a second vinyl-based monomer comprising an unsaturated nitrile monomer, an acrylic-based monomer which is different from the first acrylic-based monomer of the vinyl-based copolymer (C), a heterocyclic monomer which is different from the first heterocyclic monomer of the vinyl-based copolymer (C), or a combination thereof.

The poly(meth)acrylic acid alkyl ester (D) is derived from (meth)acrylic acid alkyl ester monomer represented by the following Chemical Formula 1, and can have a weight average molecular weight of about 10,000 to about 500,000 g/mol.

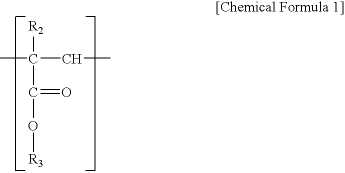

In the above Chemical Formula 1,

R₂ is hydrogen or methyl, and

R₃ is substituted or unsubstituted C1 to C8 alkyl.

The polylactic acid resin composition may further include (E) about 0.01 to about 20 parts by weight of an impact-reinforcing agent based on about 100 parts by weight of the polylactic acid resin composition. The impact-reinforcing agent (E) can be a core-shell type copolymer, a polyester-based copolymer, a polyolefin-based copolymer, or a combination thereof.

The core-shell type copolymer includes a copolymer including an unsaturated compound grafted into a rubber polymer. The unsaturated compound comprises an acrylic-based monomer, a heterocyclic monomer, an aromatic vinyl monomer, an unsaturated nitrile monomer, or a combination thereof, and the rubber polymer is obtained from polymerization of a monomer comprising a diene-based monomer, an acrylic-based monomer, a silicon-based monomer, or a combination thereof. The polyester-based copolymer or polyolefin-based copolymer is a copolymer including an epoxy group or anhydride functional group grafted on to a polyester or polyolefin main chain.

Another aspect of this disclosure provides a molded product made using the polylactic acid resin composition.

Hereinafter, further aspects of the present invention will be described in detail.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “alkyl” refers to a C1 to C8 alkyl.

As used herein, when a specific definition is not otherwise provided, the term “different kinds” and/or “different from” refers to monomers different from each other.

As used herein, when a specific definition is not otherwise provided, the term “heterocyclic monomer” refers to a C4-C20 heterocyclic monomer including one or more heteroatoms comprising N, O, S, P or a combination thereof.

As used herein, when a specific definition is not otherwise provided, the term “substituted” refers to one substituted with one or more substituents comprising halogen (F, Cl, Br, I), a hydroxy, a C1 to C20 alkoxy, a C1 to C20 alkyl, a C2 to C16 alkynyl, a C6 to C20 aryl, a C7 to C13 an arylalkyl, a C1 to C4 oxyalkyl, a C1 to C20 heteroalkyl, a C3 to C20 heteroarylalkyl, a C3 to C20 cycloalkyl, a C3 to C15 cycloalkenyl, a C6 to C15 cycloalkynyl, a C2 to C20 heterocycloalkyl, or a combination thereof.

In the present specification, when a specific definition is not otherwise provided, the term “hetero” refers to one including one or more hydrogen atoms substituted with oxygen, sulfur, nitrogen, phosphorus, or a combination thereof.

The polylactic acid resin composition includes includes (A) about 10 to about 80 wt % of a polylactic acid resin; (B) about 5 to about 50 wt % of a rubber modified vinyl-based graft copolymer; (C) about 10 to about 80 wt % of a vinyl-based copolymer; and (D) about 5 to about 75 wt % of poly(meth)acrylic acid alkyl ester:

Exemplary components included in the polylactic acid resin composition according to embodiments will hereinafter be described in detail. However, these embodiments are only exemplary, and this disclosure is not limited thereto.

(A) Polylactic Acid (PLA) Resin

In general, a polylactic acid resin is a commercially-available polyester-based resin made of lactic acid and can be obtained by decomposing corn starch with biomass energy as a monomer.

The polylactic acid resin can include a repeating unit derived from a lactic acid such as an L-lactic acid, a D-lactic acid, an L,D-lactic acid, or a combination thereof.

The polylactic acid resin may include a repeating unit derived from an L-lactic acid in an amount of about 95 wt % or more, which can provide a good balance between heat resistance and formability. In one embodiment, the polylactic acid resin may include a repeating unit derived from an L-lactic acid in an amount of about 80 wt % or more and a repeating unit derived from a D-lactic acid in an amount of about 0 to about 20 wt %. In one embodiment, the polylactic acid resin may include a repeating unit derived from an L-lactic acid in an amount of about 85 to about 99.99 wt % and a repeating unit derived from a D-lactic acid in an amount of about 0.01 to about 15 wt %. When the polylactic acid resin composition includes a polylactic acid resin as described above, excellent hydrolysis resistance as well as a balance between heat resistance and formability may be obtained.

There is no particular limitation on the molecular weight or the molecular weight distribution of the polylactic acid resin, as long as it can be molded. In one embodiment, the polylactic acid resin can have a weight average molecular weight of more than about 80,000 g/mol, and in another embodiment, about 90,000 to about 500,000 g/mol. When the polylactic acid resin has a weight average molecular weight within the above range, it is possible to induce phase stability and balanced dispersion with a resin blended together with the polylactic acid resin by increasing the viscosity of the polylactic acid resin to a predetermined level.

Also, when a D-polylactic acid (PDLA) resin having a weight average molecular weight of about 10,000 g/mol is used, a stereo complex may be efficiently formed along with L-polylactic acid (PLLA) resin. As used herein, reference to the D-polylactic acid (PDLA) resin includes a resin including a repeating unit derived from D-lactic acid in an amount of more than about 95 wt %, and reference to the L-polylactic acid (PLLA) resin includes a resin including a repeating unit derived from L-lactic acid in an amount of more than about 95 wt %.

The polylactic acid resin can be a polylactic acid homopolymer, a polylactic acid copolymer, or a combination thereof.

The polylactic acid homopolymer may be prepared through ring-opening polymerization of a lactic acid comprising L-lactic acid, D-lactic acid, or a combination thereof.

The polylactic acid copolymer may be a random or block copolymer with a component that is capable of being copolymerized with the polylactic acid polymer. The component that is capable of being copolymerized with the polylactic acid polymer may include a compound having at least two functional groups being capable forming an ester-bond in the molecular structure.

Exemplary compounds having at least two functional groups capable of forming an ester bond in the molecular structure include without limitation (i) dicarboxylic acids, (ii) polyhydric alcohols, (iii) hydroxy carboxylic acids excluding lactic acid, (iv) lactones, (v) polyesters, polyethers, polycarbonates, and the like, which are derived from the above compounds, and combinations thereof.

Exemplary dicarboxylic acids (i) include without limitation C4 to C50 linear or branched saturated or unsaturated aliphatic dicarboxylic acids, C8 to C20 aromatic dicarboxylic acids, polyether dicarboxylic acids, and the like, and combinations thereof.

Exemplary aliphatic dicarboxylic acids may include without limitation succinic acid, adipic acid, sebacin acid, decane dicarboxylic acid, and the like, and combinations thereof. Exemplary aromatic dicarboxylic acids may include without limitation phthalic acid, terephthalic acid, isophthalic acid, and the like, and combinations thereof. Exemplary polyether dicarboxylic acids may include without limitation polyalkylene ethers such as polyethylene glycol, polypropylene glycol, polybutylene glycol, polyethylene polypropylene glycol, and the like and combinations thereof with a carboxyl methyl group at both ends.

Exemplary polyhydric alcohols (ii) include without limitation aliphatic polyols, aromatic polyhydric alcohols, polyalkylene ethers, and the like and combinations thereof.

Exemplary aliphatic polyols include without limitation C2 to C50 aliphatic polyols including 2 to 4 hydroxy groups such as butane diol, hexane diol, octane diol, decane diol, 1,4-cyclohexanedimetanol, glycerine, sorbitan, trimethylolpropane, neopentyl glycol, and the like, and combinations thereof.

Exemplary aromatic polyhydric alcohols may include without limitation C6 to C20 aromatic diols such as bis-hydroxy methyl benzene, hydroquinone, and the like, and combinations thereof and aromatic diols prepared by additionally reacting a C2 to C4 alkylene oxide such as ethylene oxide, propylene oxide, butylene oxide, and the like with bisphenols such as bisphenol A, bisphenol F, and the like and combinations thereof.

Exemplary polyalkylene ethers may include ether glycols such as polyethylene glycol, polypropylene glycol, and the like and combinations thereof.

Exemplary hydroxy carboxylic acids (iii) excluding lactic acid may include without limitation C3 to C10 hydroxy carboxylic acids such as glycolic acid, hydroxy butyl carboxylic acid, 6-hydroxy caproic acid, and the like and combinations thereof.

Exemplary lactones (iv) include without limitation glycolide, ε-caprolactone glycolide, ε-caprolactone, β-propinolactone, δ-butyrolactone, β-butyrolactone, γ-butyrolactone, δ-valerolactone, and the like and combinations thereof.

The polyesters, polyethers, or polycarbonates (v) can be any one generally used for preparing a lactic acid copolymer without limitation, and in one embodiment, polyester may be used.

The polyester may include an aliphatic polyester prepared from an aliphatic dicarboxylic acid and an aliphatic diol.

Exemplary aliphatic dicarboxylic acids may include without limitation succinic acid, adipic acid, sebacin acid, decanedicarboxylic acid, and the like and combinations thereof. Exemplary aliphatic diols may include without limitation C2 to C20 aliphatic diols such as ethylene glycol, propane diol, butane diol, hexane diol, octane diol, and the like, polyalkylene ethers (homopolymer or copolymer) such as polyethylene glycol, polypropylene glycol, polybutylene glycol, and the like, polyalkylene carbonates and the like and combinations thereof.

The polylactic acid resin composition may include the polylactic acid resin in an amount of about 10 to about 80 wt %, for example about 20 to about 50 wt %, based on the total weight of the polylactic acid resin composition. When the polylactic acid resin is included in an amount within the above range, an appropriate amount of biomass may be obtained and a balance between appearance and impact resistance may be obtained.

(B) Rubber Modified Vinyl-Based Graft Copolymer

The rubber modified vinyl-based graft copolymer is a copolymer including about 5 to about 95 wt % of a vinyl-based polymer grafted onto about 5 to about 95 wt % of a rubber polymer.

The vinyl-based polymer includes about 50 to about 95 wt % of a first vinyl-based monomer comprising an aromatic vinyl monomer, an acrylic-based monomer, or a combination thereof, and about 5 to about 50 wt % of a second vinyl-based monomer comprising an unsaturated nitrile monomer, an acrylic-based monomer that is different from the first acrylic-based monomer of the rubber modified vinyl-based graft copolymer (B), or a combination thereof.

Exemplary aromatic vinyl monomers may include without limitation styrene, C1 to C10 alkyl substituted styrene, halogen substituted styrene, and the like and combinations thereof. Exemplary alkyl substituted styrenes include without limitation o-ethyl styrene, m-ethyl styrene, p-ethyl styrene, α-methyl styrene, and the like and combinations thereof.

Exemplary acrylic-based monomers may include without limitation (meth)acrylic acid alkyl esters, (meth)acrylic acid esters, and the like, and combinations thereof. As used herein with reference to the (meth)acrylic acid alkyl ester, alkyl refers to a C1 to C10 alkyl. Exemplary (meth)acrylic acid alkyl esters include without limitation methyl(meth)acrylate, ethyl(meth)acrylate, propyl(meth)acrylate, butyl(meth)acrylate, and the like, and combinations thereof, and in one embodiment, methyl(meth)acrylate. Exemplary (meth)acrylic acid esters include without limitation (meth)acrylate, and the like and combinations thereof.

Exemplary unsaturated nitrile monomers include without limitation acrylonitrile, methacrylonitrile, ethacrylonitrile, and the like, and combinations thereof.

Exemplary rubber polymers include without limitation a butadiene rubber, an acrylic rubber, an ethylene/propylene rubber, a styrene/butadiene rubber, an acrylonitrile/butadiene rubber, an isoprene rubber, an ethylene-propylene-diene terpolymer (EPDM) rubber, a polyorganosiloxane/polyalkyl(meth)acrylate rubber composite, and the like, and combinations thereof.

When the rubber modified vinyl-based graft copolymer is prepared, the particle diameter of a rubber particle may range from about 0.05 μm to about 4 μm in order to improve impact resistance and the surface characteristics of a molded product. When the particle diameter of the rubber particle falls in the above range, excellent impact strength may be acquired.

The rubber modified vinyl-based graft copolymer may be used alone or in the form of a mixture of more than two kinds of rubber modified vinyl-based graft copolymers.

One example of the rubber modified vinyl-based graft copolymer is a polymer of styrene, acrylonitrile, and optionally methyl(meth)acrylate graft-copolymerized onto a butadiene rubber, an acrylic rubber, a styrene/butadiene rubber or a combination thereof.

Another example of the rubber modified vinyl-based graft copolymer is methyl(meth)acrylate graft-copolymerized onto a butadiene rubber, an acrylic rubber, a styrene/butadiene rubber, or a combination thereof.

Methods for preparing the rubber modified vinyl-based graft copolymer are widely known to those skilled in the art, and any method such as emulsion polymerization, suspension polymerization, solution polymerization, and bulk polymerization may be used. For example, the rubber modified vinyl-based graft copolymer can be prepared by emulsion polymerization or bulk polymerization by adding the above-described aromatic vinyl monomer in the presence of a rubber polymer and using a polymerization initiator.

The polylactic acid resin composition may include the rubber modified vinyl-based graft copolymer in an amount ranging from about 5 wt % to about 50 wt %, for example about 10 wt % to about 30 wt %, based on the total weight of the polylactic acid resin. When the rubber modified vinyl-based graft copolymer is included in an amount within this range, the polylactic acid resin composition may have both excellent appearance characteristics and impact resistance.

(C) Vinyl-Based Copolymer

The vinyl-based copolymer (C) may include a copolymer of about 40 to about 95 wt % of a first vinyl-based monomer comprising an aromatic vinyl monomer, an acrylic-based monomer, a heterocyclic monomer, or a combination thereof; and about 5 to about 60 wt % of a second vinyl-based monomer comprising an unsaturated nitrile monomer, an acrylic-based monomer that is different from the first acrylic-based monomer of the vinyl-based copolymer (C), a heterocyclic monomer that is different from the first heterocyclic monomer of the vinyl-based copolymer (C), or a combination thereof. When the vinyl-based copolymer includes the vinyl-based monomers in the above content ratio, thermochromic property and chemical resistance may be improved.

Exemplary aromatic vinyl monomers may include without limitation styrene, C1 to C10 alkyl substituted styrene, halogen substituted styrene, or a combination thereof. Exemplary alkyl substituted styrenes include without limitation o-ethyl styrene, m-ethyl styrene, p-ethyl styrene, α-methyl styrene, and the like and combinations thereof.

Exemplary acrylic-based monomers may include without limitation (meth)acrylic acid alkyl esters, (meth)acrylic acid esters, and the like, and combinations thereof. As used herein with reference to the (meth)acrylic acid alkyl ester, alkyl refers to a C1 to C10 alkyl. Exemplary (meth)acrylic acid alkyl esters include without limitation methyl(meth)acrylate, ethyl(meth)acrylate, propyl(meth)acrylate, butyl(meth)acrylate, and the like, and combinations thereof, and in one embodiment, methyl(meth)acrylate. Exemplary (meth)acrylic acid esters include without limitation (meth)acrylate, and the like and combinations thereof.

Exemplary heterocyclic monomers include without limitation maleic anhydride, C1 to C10 alkyl or phenyl N-substituted maleimide, and the like and combinations thereof.

Exemplary unsaturated nitrile monomers include without limitation acrylonitrile, methacrylonitrile, ethacrylonitrile, and the like and combinations thereof.

The vinyl-based copolymer may be generated as a byproduct when the rubber modified vinyl-based graft copolymer is prepared. For example, the vinyl-based copolymer may be generated when an excessive amount of vinyl-based polymer is grafted into a small amount of a rubber polymer or when a chain transfer agent, which is used as a molecular weight controlling agent, is used in an excessive amount.

Exemplary vinyl-based copolymers may include without limitation a copolymer of styrene, acrylonitrile, and optionally methylmethacrylate; a copolymer of α-methylstyrene, acrylonitrile, and optionally methylmethacrylate; a copolymer of styrene, α-methylstyrene, acrylonitrile, and optionally methylmethacrylate, and the like, and combinations thereof.

The vinyl-based copolymer may be prepared through an emulsion polymerization, a suspension polymerization, a solution polymerization or a bulk polymerization, and the vinyl-based copolymer which is used may have a weight average molecular weight ranging from about 15,000 g/mol to about 400,000 g/mol.

Another example of the vinyl-based copolymer may be a copolymer formed of methylmethacrylate and optionally methylacrylate. The vinyl-based copolymer may be prepared through an emulsion polymerization, a suspension polymerization, a solution polymerization or a bulk polymerization, and the vinyl-based copolymer which is used may have a weight average molecular weight ranging from about 20,000 g/mol to about 250,000 g/mol.

Another example of the vinyl-based copolymer is a copolymer of styrene and maleic anhydride, which may be prepared through a continuous bulk polymerization or solution polymerization. The composition ratio of the styrene and the maleic anhydride may vary over a wide range. In one embodiment, the maleic anhydride may be included in an amount ranging from about 5 wt % to about 50 wt % based on the total amount of the vinyl-based copolymer. The copolymer of styrene and maleic anhydride which is used may have a weight average molecular weight over a wide range. In one embodiment, a copolymer of styrene and maleic anhydride having a weight average molecular weight of about 20,000 g/mol to about 200,000 g/mol and an inherent viscosity of about 0.3 dl/g to about 0.9 dl/g may be used.

The polylactic acid resin composition may include the vinyl-based copolymer in an amount ranging from about 10 wt % to about 80 wt %, for example about 10 wt % to about 30 wt %, based on the total weight of the polylactic acid resin composition. When the vinyl-based copolymer is included in an amount in the above range, a balance between excellent appearance characteristics and impact resistance may be achieved.

(D) Poly(meth)acrylic Acid Alkyl Ester

The poly(meth)acrylic acid alkyl ester is derived from (meth)acrylic acid alkyl ester monomer represented by the following Chemical Formula 1. The poly(meth)acrylic acid alkyl ester may be acquired by polymerizing the (meth)acrylic acid alkyl ester monomer through a bulk polymerization, an emulsion polymerization, a suspension polymerization or a solution polymerization.

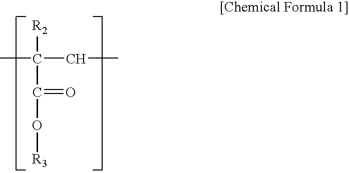

In the above Chemical Formula 1,

R₂ is hydrogen or methyl, and

R₃ is substituted or unsubstituted C1 to C8 alkyl.

Exemplary (meth)acrylic acid alkyl ester monomers include without limitation methacrylic acid methyl ester, methacrylic acid ethyl ester, methacrylic acid propyl ester, acrylic acid methyl ester, acrylic acid ethyl ester, and the like, and combinations thereof, and in one embodiment, is methacrylic acid methyl ester.

The poly(meth)acrylic acid alkyl ester can have a weight average molecular weight of about 10,000 g/mol to about 500,000 g/mol, and in one embodiment, about 15,000 g/mol to about 350,000 g/mol. When a poly(meth)acrylic acid alkyl ester having a weight average molecular weight in the above range is used, the polylactic acid resin composition may exhibit a balanced flow and the phases may be more stabilized.

The polylactic acid resin composition may include the poly(meth)acrylic acid alkyl ester in an amount ranging from about 5 wt % to about 75 wt %, for example about 5 wt % to about 30 wt %, based on the total weight of the polylactic acid resin composition. When the poly(meth)acrylic acid alkyl ester is included in an amount in the above range, the polylactic acid resin composition may have excellent gloss, impact strength and dimensional stability.

(E) Impact-Reinforcing Agent

The polylactic acid resin composition may further include an impact-reinforcing agent to improve impact strength.

Exemplary impact-reinforcing agents include without limitation core-shell type copolymers, polyester-based copolymers, polyolefin-based copolymers, and the like, and combinations thereof.

The core-shell type copolymer has a core-shell structure wherein unsaturated monomers are grafted into a rubber core to form a hard shell. The core-shell type copolymer can be obtained by grafting an unsaturated compound comprising an acrylic-based monomer, a heterocyclic monomer, an aromatic vinyl monomer, an unsaturated nitrile monomer, or a combination thereof, onto a rubber polymer obtaining by polymerization of a diene-based monomer, an acrylic-based monomer, a silicon-based monomer, or a combination thereof.

Exemplary diene-based monomers include without limitation C4 to C6 butadiene, isoprene, and the like. Exemplary rubber polymers obtained from polymerization of the diene-based monomer can include without limitation a butadiene rubber, an acrylic rubber, a styrene/butadiene rubber, an acrylonitrile/butadiene rubber, an isoprene rubber, a terpolymer (EPDM) of ethylene-propylene-diene, and the like and combinations thereof.

Exemplary acrylic-based monomers include without limtiation methyl(meth)acrylate, ethyl(meth)acrylate, n-propyl(meth)acrylate, n-butyl(meth)acrylate, hexyl(meth)acrylate, 2-ethylhexyl(meth)acrylate, and the like and combinations thereof. Curing agents such as but not limited to ethylene glycol di(meth)acrylate, propylene glycol di(meth)acrylate, 1,3-butylene glycol di(meth)acrylate, 1,4-butylene glycol di(meth)acrylate, allyl(meth)acrylate, triallylcyanurate, and the like and combinations thereof may be used along with the acrylic-based monomer.

The silicon-based monomer includes a cyclosiloxane compound, such as but not limited to hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like and combinations thereof. Curing agents such as trimethoxymethylsilane, triethoxyphenylsilane, tetramethoxysilane, tetraethoxysilane, and the like and combinations thereof may be used along with the silicon-based monomer.

The rubber polymer can have an average particle diameter ranging from about 0.4 μm to about 1 μm which can provide a balance of impact resistance and coloring properties.

Exemplary acrylic-based monomers of the unsaturated compound may include without limitation (meth)acrylic acid alkyl esters, (meth)acrylic acid esters, and the like and combinations thereof. As used herein with reference to the (meth)acrylic acid alkyl ester, the alkyl is a C1 to C10 alkyl. Exemplary (meth)acrylic acid alkyl esters include without limitation methyl(meth)acrylate, ethyl(meth)acrylate, propyl(meth)acrylate, butyl(meth)acrylate, and the like, and combinations thereof, and in one embodiment is methyl(meth)acrylate. Exemplary (meth)acrylic acid esters include without limitation (meth)acrylate, and the like and combinations thereof.

Exemplary heterocyclic monomers may include without limitation maleic anhydride, C1 to C10 alkyl or phenyl N-substituted maleimide, and the like and combinations thereof.

Exemplary aromatic vinyl monomers include without limitation styrene, C1-C10 alkyl-substituted styrene, halogen-substituted styrene, and the like and combinations thereof. Exemplary alkyl substituted styrene includes o-ethyl styrene, m-ethyl styrene, p-ethyl styrene, α-methyl styrene, and the like and combinations thereof.

Exemplary unsaturated nitrile monomers include without limitation acrylonitrile, methacrylonitrile, ethacrylonitrile, and the like and combinations thereof.

An example of a polymer formed from at least one monomer among the unsaturated compounds is polymethylmethacrylate.

The core-shell type copolymer may have an average particle size of about 0.1 μm to about 0.5 μm. When the core-shell type copolymer has an average particle size in the above range, the polylactic acid resin can be well dispersed in a matrix so that when an outside impact is applied, the impact can be easily absorbed to thereby increase the impact-reinforcing effect.

The core-shell type copolymer may include about 50 wt % to about 95 wt % of the rubber polymer and about 5 wt % to about 50 wt % of an unsaturated compound grafted thereinto. When the core-shell type copolymer includes the rubber polymer and the unsaturated compound in the above content ratio, it may have excellent compatibility with a polylactic acid resin so that the impact-reinforcing effect may be maximized.

The polyester-based copolymer or polyolefin-based copolymer is a copolymer including an epoxy group or anhydride functional group grafted onto a polyester or polyolefin main chain.

The polyolefin-based main chain may be obtained by polymerization of a monomer such as ethylene, propylene, butylene, isobutylene, and the like and combinations thereof.

The polyester-based copolymer or polyolefin-based copolymer can be prepared by using a Ziegler-Natta catalyst, which is an olefin polymerization catalyst, or a metallocene-based catalyst for a more selective structure.

The polylactic acid resin composition may include the impact-reinforcing agent in an amount ranging from about 0.01 to 20 parts by weight, for example about 5 to about 20 parts by weight, based on about 100 parts by weight of the polylactic acid resin composition. When the impact-reinforcing agent is included in an amount in the above range, the impact-reinforcing effect and the heat resistance may be increased, and the fluidity can be improved as well so that injection molding properties may be improved.

(F) Other Additive(s)

The polylactic acid resin composition may further include one or more additives. Exemplary additives include without limitation antioxidants, release agents, weather-resistance agents, colorants, ultraviolet (UV) blocking agents, filler, nucleating agents, plasticizers, flame retardants, and the like and combinations thereof according to each use.

Exemplary antioxidants may include without limitation phenol-type antioxidants, phosphite-type antioxidants, thioether-type antioxidants, amine-type antioxidants, and the like and combinations thereof. Exemplary release agents may include without limitation fluorine-containing polymers, silicone oils, metal salts of stearic acid, metal salts of montanic acid, montanic acid ester waxes, polyethylene waxes and the like and combinations thereof. Exemplary weather-resistance agents may include without limitation benzophenone-type weather-resistance agents, amine-type weather-resistance agents, and the like, and combinations thereof. Exemplary colorants may include without limitation dyes, pigments, and the like and combinations thereof. Exemplary ultraviolet (UV) blocking agents may include without limitation titanium oxide (TiO₂), carbon black, and the like and combinations thereof. Exemplary filler may include without limitation glass fiber, carbon fiber, silica, mica, alumina, clay, calcium carbonate, calcium sulfate, glass beads, and the like and combinations thereof. When the fillers are added, properties such as mechanical strength, heat resistance, and the like may be improved. Exemplary nucleating agents may include without limitation talc, clay, and the like, and combinations thereof. Exemplary plasticizers include without limitation polyester-based plasticizers, glycerine-based plasticizers, phosphoric acid ester plasticizers, polyalkylene glycol-based plasticizers, epoxy-based plasticizers, and the like and combinations thereof. Exemplary flame retardants include without limitation bromine-based flame retardants, phosphorus-based flame retardants, antimony-containing compounds, melamine compounds, and the like and combinations thereof.

The additive may be included in any suitable amount as known in the art as long as the additive does not inhibit the physical properties of the polylactic acid resin composition. In one embodiment, the additive may be included in an amount ranging from about 0.1 to about 30 parts by weight based on about 100 parts by weight of the polylactic acid resin composition.

The polylactic acid resin composition according to one embodiment may be prepared using known methods for preparing a resin composition. For example, the polylactic acid resin composition may be prepared in the form of pellets or chips through a conventional method, such as mixing the above component optionally with additives and then melt-extruding the mixture in an extruder.

The polylactic acid resin composition according to one embodiment can have a three-phase structure of polylactic acid resin/rubber modified vinyl-based graft copolymer/poly(meth)acrylic acid alkyl ester by adding the poly(meth)acrylic acid alkyl ester not as a compatibilizer but as one of resins. Thus, the appearance characteristics, gloss, and impact strength of the polylactic acid resin composition may be improved and also, it may further include an impact-reinforcing agent to further enhance the impact strength.

According to another embodiment, a molding product is manufactured by molding the polylactic acid resin composition, which is described above. Any suitable molding technique known in the art may be used, such as but not limited to extrusion molding, injection molding, blow molding and the like. The skilled artisan will understand how to prepare a molded product using the polylactic acid resin composition of the invention without undue experimentation.

The polylactic acid resin composition may be useful in the manufacture of molded products requiring excellent appearance characteristics, gloss and impact strength, for example, automobile parts, mechanical parts, electrical/electronic parts, office equipment such as computers, and other general merchandise. For example, the polylactic acid resin composition may be used in housings for electrical/electronic products, such as but not limited to televisions, computers, printers, washing machines, cassette players, stereos, mobile phones and the like.

The following examples illustrate the present invention in more detail. However, the following are exemplary embodiments and are not limiting.

### EXAMPLES

Each component of a polylactic acid resin composition is as follows.

(A) Polylactic Acid Resin

4032D produced by NatureWorks LLC., U.S. is used.

(B) Rubber Modified Vinyl-Based Graft Copolymer

An ABS graft copolymer is prepared by adding butadiene rubber latex in such a manner that the amount of butadiene is about 58 parts by weight based on 100 parts by weight of the total amount of a monomer and adding additives, which include about 1.0 parts by weight of oleic acid potassium (auxiliary initiator), about 0.4 parts by weight of cumenehydroperoxide (initiator), and about 0.3 parts by weight of t-dodecyl mercaptan (chain-transfer agent), to a mixture of about 31 parts by weight of styrene, about 11 parts by weight of acrylonitrile, and about 150 parts by weight of deionized water and causing a reaction for about 5 hours while maintaining a temperature of about 75° C. A power-type rubber modified vinyl-based graft copolymer resin of a core-shell structure having an average particle diameter of about 0.3 μm is prepared by adding about 1% sulfuric acid solution to the produced polymer latex, solidifying the mixture solution, and drying it.

(C) Vinyl-Based Copolymer

A styrene-acrylonitrile (SAN) copolymer resin is prepared by adding about 0.17 parts by weight of azobisisobutyronitrile, about 0.4 parts by weight of t-dodecyl mercaptan and about 0.5 parts by weight of tricalciumphosphate to a mixture of about 21 parts by weight of styrene, about 79 parts by weight of methacrylic acid, about 5 parts by weight of acrylonitrile, and about 120 parts by weight of deionized water, and the resultant solution is suspension-polymerized for about 5 hours at a temperature of about 75° C. The SAN copolymer resin is rinsed, dehydrated and dried to thereby produce a powder-type m-SAN copolymer resin.

(D) Poly(meth)acrylic Acid Alkyl Ester

IH-830 produced by LG Company is used as a polymethylmethacrylate.

(E) Impact-Reinforcing Agent

223-A(methyl methacrylate-butadiene ethylacrylate copolymer) produced by MRC Company is used.

(F) Dicarboxylic Anhydride

EXXELOR VA 1803 (maleic anhydride grafted ethylene propylene rubber) produced by EXXON Chemical Company is used as a Comparative Example.

### Examples 1 to 8 and Comparative Examples 1 to 5

A polylactic acid resin composition may be prepared by mixing the components according to the amounts presented in the following Table 1, and manufacturing pellets by performing an extrusion in a two-axis extruder at a temperature ranging from about 200 to about 230° C. The unit for the amounts of the components shown in the following Table 1 is wt %.

TABLE 1

| | | | | | | | | | | Comparative | | | | |
|---|---|---|---|---|---|---|---|---|---|---|---|---|---|---|
| | | Examples | | | | | | | | Examples | | | | |
| | | 1 | 2 | 3 | 4 | 5 | 6 | 7 | 8 | 1 | 2 | 3 | 4 | 5 |
| (A) | polylactic acid resin | 40 | 40 | 40 | 50 | 30 | 40 | 40 | 40 | 40 | 40 | 30 | 30 | 50 |
| (B) | rubber modified vinyl-based | 20 | 20 | 20 | 20 | 20 | 15 | 10 | 25 | 20 | — | 15 | 20 | — |
| | graft copolymer | | | | | | | | | | | | | |
| (C) | vinyl-based copolymer | 10 | 20 | 30 | 10 | 20 | 10 | 10 | 10 | 35 | — | 50 | 20 | 25 |
| (D) | poly(meth)acrylic acid alkyl | 25 | 15 | 5 | 15 | 25 | 25 | 25 | 25 | — | 55 | — | 25 | — |
| | ester | | | | | | | | | | | | | |
| (E) | impact-reinforcing agent | 5 | 5 | 5 | 5 | 5 | 10 | 15 | — | 5 | 5 | 5 | — | 25 |
| (F) | dicarboxylic anhydride | — | — | — | — | — | — | — | — | — | — | — | 5 | — |

[Assessment of Physical Property]

Specimens for physical property tests are prepared by drying the pellets manufactured according to Examples 1 to 8 and Comparative Examples 1 to 5 for about 4 hours at about 80° C., setting an injection molding machine with an injection capability of about 6 oz at a cylinder temperature of about 220° C., metal molding temperature of about 60° C. and a molding cycle of about 30 seconds, and injection-molding the pellets with the injection molding machine into ASTM dumb-bell specimens.

The physical properties of the produced physical specimens are measured in accordance with the following methods, and the measurement results are shown in the following Table 2.

1) Tensile strength: measured according to ASTM D638.

2) Flexural strength: measured according to ASTM D790.

3) Flexural modulus: measured according to ASTM D790.

4) 120D impact strength: measured according to ASTM D256 (specimen thickness ⅛″).

5) Gloss: measured according to ASTM D523 (incident light:) 60°

6) Flow mark: Pin-point 2T specimens are injection-molded and observed with the naked eye.
◯: Flow mark is observed.
X: Flow mark is not observed.

TABLE 2

| | Examples | | | | | | | | Comparative Examples | | | | |
|---|---|---|---|---|---|---|---|---|---|---|---|---|---|
| | 1 | 2 | 3 | 4 | 5 | 6 | 7 | 8 | 1 | 2 | 3 | 4 | 5 |
| Tensile | 520 | 470 | 420 | 540 | 500 | 500 | 480 | 510 | 400 | 620 | 380 | 420 | 450 |
| strength | | | | | | | | | | | | | |
| (kgf/cm2) | | | | | | | | | | | | | |
| Flexural | 770 | 701 | 680 | 790 | 730 | 760 | 730 | 740 | 640 | 850 | 635 | 690 | 710 |
| strength | | | | | | | | | | | | | |
| (kgf/cm²) | | | | | | | | | | | | | |
| Flexural | 27,120 | 23,266 | 21,430 | 28,016 | 25,640 | 26,010 | 24,890 | 26,450 | 19,840 | 29,600 | 19,040 | 21,610 | 23,100 |
| modulus | | | | | | | | | | | | | |
| (kgf/cm²) | | | | | | | | | | | | | |
| Impact | 31 | 28 | 26 | 25 | 28 | 29 | 25 | 29 | 18 | 6 | 15 | 4 | 15 |
| strength | | | | | | | | | | | | | |
| (kgf · cm/ | | | | | | | | | | | | | |
| cm) | | | | | | | | | | | | | |
| Gloss (%) | 81 | 79 | 75 | 79 | 80 | 79 | 76 | 82 | 65 | 82 | 69 | 59 | 65 |
| Flow mark | x | x | x | x | x | x | x | x | ∘ | x | ∘ | ∘ | x |

As demonstrated in Tables 1 and 2, the resin compositions prepared according to Examples 1 to 8 using polylactic acid resin, a rubber modified vinyl-based graft copolymer, vinyl-based copolymer and poly(meth)acrylic acid alkyl ester have excellent impact strength, appearance characteristics, and glass.

Although the resin composition of Example 5 includes a smaller amount of polylactic acid resin than that of Example 1, there is not much difference in terms of physical properties. Since the resin composition of Example 1 including a greater amount of polylactic acid, it can be considered desirable from a disposal standpoint.

The resin compositions of Examples 2 and 3 including a smaller amount of poly(meth)acrylic acid alkyl ester than the resin composition of Example 1 have lower gloss and impact strength than the resin composition of Example 1.

The resin composition of Example 4 including the greatest amount of polylactic acid has a slightly lower impact strength than the resin composition of Example 1, but it has generally excellent physical properties and appearance. It is believed that the impact-reinforcing agent can improve impact strength as grafted methylmethacrylate selectively migrates toward the polylactic acid resin and poly(meth)acrylic acid alkyl ester phases.

The resin compositions of Examples 6 and 7 include rubber, the amount of which is increased to about 25 parts by weight by sequentially increasing the amount of the impact-reinforcing agent by 5 wt % compared with the resin composition of Example 1 while relatively decreasing the amount of the rubber modified vinyl-based graft copolymer. In this case, the resin compositions of Examples 6 and 7 have physical properties and gloss that are slightly lower than the resin composition of Example 1.

The resin composition of Example 8 includes an increased amount of the rubber modified vinyl-based graft copolymer without using any impact-reinforcing agent. The resin composition of Example 8 is excellent in terms of appearance characteristics and physical properties, except that the impact strength of the resin composition is slightly decreased compared with the resin composition of Example 1.

The resin composition of Comparative Example 5, which includes the impact-reinforcing agent replacing the entire amount of the rubber modified vinyl-based graft copolymer, has a drastic deterioration in the impact strength and gloss. Therefore, it can be important to control the amount of the impact-reinforcing agent.

The resin composition of Comparative Example 1 includes vinyl-based copolymer resin replacing the entire amount of poly(meth)acrylic acid alkyl ester. In this case, the gloss and impact strength are drastically deteriorated. Therefore, adding poly(meth)acrylic acid alkyl ester can be important to improve the appearance characteristics.

The resin composition of Comparative Example 2, which includes poly(meth)acrylic acid alkyl ester replacing the total amount of the rubber modified vinyl-based graft copolymer and the vinyl-based copolymer resin, has an excellent appearance characteristic but its impact strength is drastically deteriorated. It may be seen from these results that the appearance characteristic, gloss, and impact strength may be balanced when a resin composition includes all the three components, i.e., the rubber modified vinyl-based graft copolymer, the vinyl-based copolymer and the poly(meth)acrylic acid alkyl ester.

The resin composition of Comparative Example 4, which includes polymethylmethacrylate as a compatibilizer and dicarboxylic anhydride added thereto, shows flow marks and remarkably deteriorated gloss. As a result, the resin composition of Comparative Example 4 has poor appearance characteristics.

In summary, a three-phase structure of polylactic acid resin/rubber modified vinyl-based graft copolymer/poly(meth)acrylic acid alkyl ester is acquired by adding poly(meth)acrylic acid alkyl ester to the polylactic acid resin composition not as a compatibilizer but as a background resin, and thus the polylactic acid resin composition may have improved appearance characteristics, gloss, and impact strength. Furthermore, including an impact-reinforcing agent in the polylactic acid resin composition may further improve impact strength.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polylactic acid resin composition comprising:
(A) about 10 to about 80 wt % of a polylactic acid resin;
(B) about 5 to about 50 wt % of a rubber modified vinyl-based graft copolymer;
(C) about 10 to about 80 wt % of a vinyl-based copolymer; and
(D) about 5 to about 75 wt % of poly(meth)acrylic acid alkyl ester

2. The polylactic acid resin composition of claim 1, wherein the rubber modified vinyl-based graft copolymer (B) comprises
about 5 to about 95 wt % of a vinyl-based polymer comprising about 50 to about 95 wt % of a first vinyl-based monomer comprising an aromatic vinyl monomer, an acrylic-based monomer, or a combination thereof; and about 5 to about 50 wt % of a second vinyl-based monomer comprising an unsaturated nitrile monomer, an acrylic-based monomer that is different from the first acrylic-based monomer of the rubber modified vinyl-based graft copolymer (B), or a combination thereof,
which are grafted onto about 5 to about 95 wt % of a rubber polymer comprising a butadiene rubber, an acrylic rubber, an ethylene/propylene rubber, a styrene/butadiene rubber, an acrylonitrile/butadiene rubber, an isoprene rubber, an ethylene-propylene-diene terpolymer, a polyorganosiloxane/polyalkyl(meth)acrylate rubber composite, or a combination thereof.

3. The polylactic acid resin composition of claim 1, wherein the vinyl-based copolymer (C) comprises a copolymer comprising about 40 to about 95 wt % of a first vinyl-based monomer comprising an aromatic vinyl monomer, an acrylic-based monomer, a heterocyclic monomer, or a combination thereof; and about 5 to about 60 wt % of a second vinyl-based monomer comprising an unsaturated nitrile monomer, an acrylic-based monomer that is different from the first acrylic-based monomer of the vinyl-based copolymer (C), a heterocyclic monomer that is different from first heterocyclic monomer of the vinyl-based copolymer (C), or a combination thereof.

4. The polylactic acid resin composition of claim 1; wherein the poly(meth)acrylic acid alkyl ester (D) is derived from (meth)acrylic acid alkyl ester monomer represented by the following Chemical Formula 1: 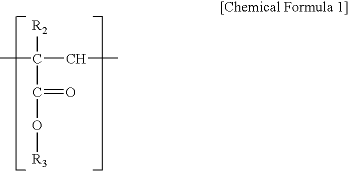
wherein in the above Chemical Formula 1, R₂ is hydrogen or methyl, and
R₃ is substituted or unsubstituted C1 to C8 alkyl.

5. The polylactic acid resin composition of claim 1, wherein the poly(meth)acrylic acid alkyl ester (D) has a weight average molecular weight of about 10,000 to about 500,000 g/mol.

6. The polylactic acid resin composition of claim 1, wherein the polylactic acid resin composition includes about 0.01 to about 20 parts by weight of an (E) impact-reinforcing agent based on about 100 parts by weight of the polylactic acid resin composition.

7. The polylactic acid resin composition of claim 6, wherein the impact-reinforcing agent (E) comprises a core-shell type copolymer, a polyester-based copolymer, a polyolefin-based copolymer, or a combination thereof.

8. The polylactic acid resin composition of claim 7, wherein the core-shell type copolymer comprises a copolymer including an unsaturated compound grafted on to a rubber polymer,
wherein the unsaturated compound comprises an acrylic-based monomer, a heterocyclic monomer, an aromatic vinyl monomer, an unsaturated nitrile monomer, or a combination thereof, and the rubber polymer is obtained polymerization of a monomer comprising a diene-based monomer, an acrylic-based monomer, a silicon-based monomer, or a combination thereof.

9. The polylactic acid resin composition of claim 7, wherein the polyester-based copolymer or polyolefin-based copolymer is a copolymer including an epoxy group or anhydride functional group grafted on to a polyester or polyolefin main chain.

10. A molded product made using the polylactic acid resin composition according to claim 1.
